(19) United States
(12) Patent Application Publication
(10) Pub. No.: US 2013/0307980 A1
(43) Pub. Date: Nov. 21, 2013

(54) SYSTEM AND METHOD FOR REAL TIME SECURITY DATA ACQUISITION AND INTEGRATION FROM MOBILE PLATFORMS

(71) Applicant: TRANSPORTATION SECURITY ENTERPRISES, INC. (TSE), El Dorado Hills, CA (US)

(72) Inventors: Douglas M. Stone, Placerville, CA (US); Patrick Harrington, Sacramento, CA (US); Brian C. Wiles, Cameron Park, CA (US)

(73) Assignee: Transportation Security Enterprises, Inc. (TSE), El Dorado Hills, CA (US)

(21) Appl. No.: 13/662,445

(22) Filed: Oct. 27, 2012

Related U.S. Application Data
(63) Continuation-in-part of application No. 13/602,319, filed on Sep. 3, 2012.
(60) Provisional application No. 61/649,346, filed on May 20, 2012.

(51) Int. Cl. H04N 7/18

(52) U.S. Cl. 348/148; 348/143; 348/E07.085

(57) ABSTRACT

A system and method for real time security data acquisition and integration from mobile platforms are disclosed. A particular embodiment includes: deploying a plurality of sensors and video sources in a monitored venue, the plurality of sensors and video sources generating security data in the monitored venue; receiving the security data wirelessly in real time at a real time wireless data integrator positioned adjacent to the monitored venue; establishing a real time wireless data integrator network between at least two real time wireless data integrators; and causing the transfer of the security data to an operations center via a network.

### PRIORITY PATENT APPLICATIONS

This is a continuation-in-part patent application of co-pending U.S. patent application, Ser. No. 13/602,319; filed Sep. 3, 2012 by the same applicant. This non-provisional U.S. patent application also claims priority to U.S. provisional patent application, serial no 61/649,346; filed on May 20, 2012 by the same applicant as the present patent application. This present patent application draws priority from the referenced patent applications. The entire disclosure of the referenced patent applications is considered part of the disclosure of the present application and is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2010-2012, Transportation Security Enterprises, Inc. (TSE); All Rights Reserved.

### TECHNICAL FIELD

This patent application relates to a system and method for use with networked computer systems, real time data collection systems, and sensor systems, according to one embodiment, and more specifically, to a system and method for real time security data acquisition and integration from mobile platforms.

### BACKGROUND

The inventor of the present application, armed with personal knowledge of violent extremist suicide bomber behaviors, determined that the “insider, lone wolf, suicide bomber” was the most difficult enemy to counter. The inventor, also armed with the history of mass transit passenger rail bombings by violent extremist bombers, determined that the soft target of mass transport was the most logical target. As such, the security of passengers or cargo utilizing various forms of mass transit has increasingly become of great concern worldwide. The fact that many high capacity passenger and/or cargo mass transit vehicles or mass transporters, such as, ships, subways, trains, trucks, buses, and aircraft, have been found to be “soft targets” have therefore increasingly become the targets of hostile or terrorist attacks. The problem is further exacerbated given that there are such diverse methods of mass transit within even more diverse environments. The problem is also complicated by the difficulty in providing a high bandwidth data connection with a mobile mass transit vehicle. Therefore, a very comprehensive and unified solution is required. For example, attempts to screen cargo and passengers prior to boarding have improved safety and security somewhat, but these solutions have been few, non-cohesive, and more passive than active. Conventional systems do not provide an active, truly viable real time solution that can effectively, continuously, and in real time monitor and report activity at a venue, trends in visitor and passenger behavior, and on-board status information for the duration of a vehicle in transit, and in response to adverse conditions detected, actively begin the mitigation process by immediately alerting appropriate parties and systems. Although there have been certain individual developments proposed in current systems regarding different individual aspects of the overall problem, no system has yet been developed to provide an active, comprehensive, fully-integrated real time system to deal with the entire range of issues and requirements involved within the security and diversity of mass transit. In particular, conventional systems do not provide the necessary early detection in real time, and potentially aid in the prevention of catastrophic events. Separate isolated systems that have difficulty aggregating information and are not in real time, nor aggregated against enough information to allow for a composite alert or pre-alert conclusion.

In many cases, it becomes necessary to collect and aggregate information from mobile platforms, such as mass transit vehicles. However, the acquisition, processing, retention, and distribution of this information in real time can be highly problematic given the logistical problems of transferring data to and from a moving vehicle. Conventional systems have been unable to effectively solve this problem.

### BRIEF DESCRIPTION OF THE DRAWINGS

The various embodiments is illustrated by way of example, and not by way of limitation, in the figures of the accompanying drawings in which:

FIG. 1 illustrates an example embodiment of a system and method for real time data analysis;

FIG. 2 illustrates an example embodiment of the functional components of the real time data analysis system;

FIG. 3 illustrates an example embodiment of the functional components of the analysis tools module;

FIG. 4 illustrates an example embodiment of the functional components of the rule manager;

FIG. 5 illustrates an example embodiment of the functional components of the data acquisition systems for acquiring security information or biometrics at a mobile venue;

FIG. 6 illustrates an example embodiment of the structural components of the edge device data aggregator;

FIG. 7 illustrates an example embodiment of the structural components of the real time wireless data integrator;

FIG. 8 illustrates an example embodiment of a system environment in which the real time wireless data integrator can operate;

FIGS. 9 and 10 are processing flow charts illustrating an example embodiment of a system and method for real time handoff of data communications in a security data acquisition and integration system as described herein;

FIG. 11 is a processing flow chart illustrating an example embodiment of a system and method for real time security data acquisition and integration from mobile platforms as described herein;

FIG. 12 is a processing flow chart illustrating an example embodiment of a system and method for real time data analysis as described herein; and

FIG. 13 shows a diagrammatic representation of machine in the example form of a computer system within which a set of instructions when executed may cause the machine to perform any one or more of the methodologies disclosed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

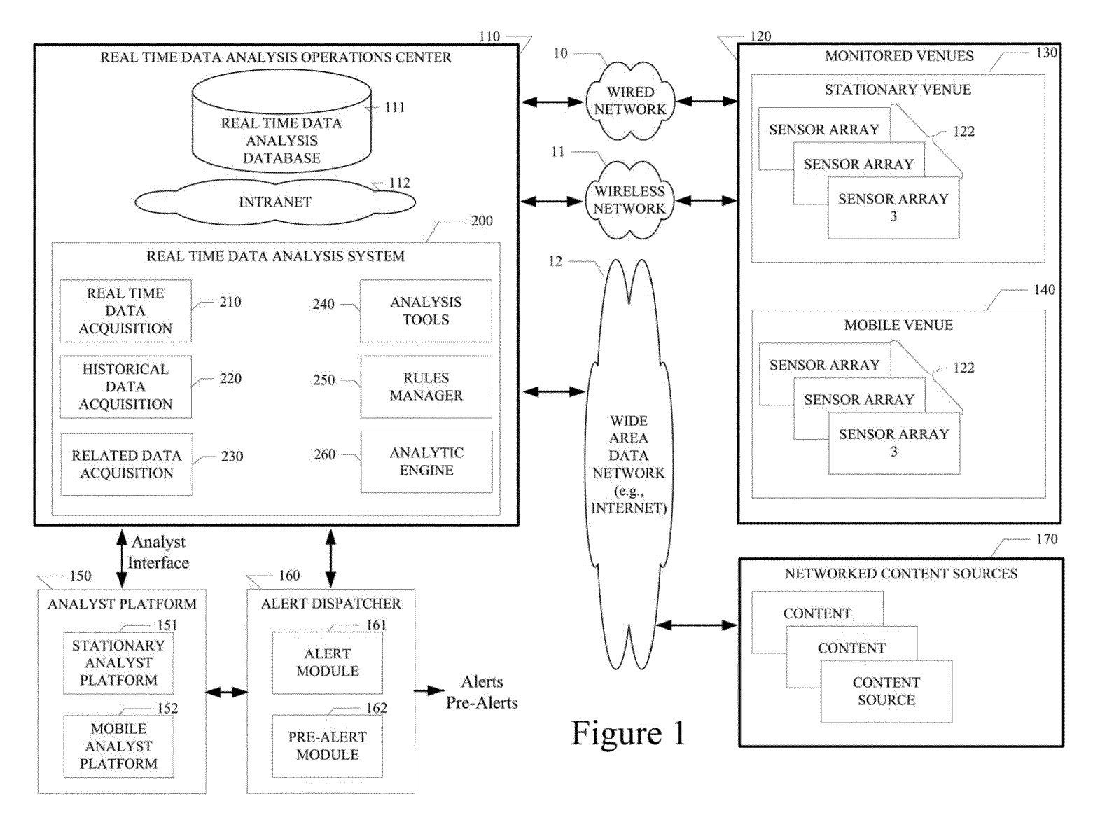

Referring to FIG. 1, in an example embodiment, a system and method for real time security data acquisition and integration from mobile platforms are disclosed. In various example embodiments, a real time data analysis system 200, typically operating in or with a real time data analysis operations center 110, is provided to support the real time analysis of data captured from a variety of sensor arrays. A plurality of monitored venues 120, at which a plurality of sensor arrays 122 are deployed, are in network communication with the real time data analysis operations center 110 via a wired network 10 or a wireless network 11. As described in more detail below, the monitored venues 120 can be stationary venues 130 and/or mobile venues 140. The sensor arrays 122 can be virtually any form of data or image gathering and transmitting device. In one embodiment, a sensor of sensor arrays 122 can include a standard surveillance video camera or other device for capturing or acquiring security information or biometrics. The term, ‘security information’, as used herein, refers to a variety of information obtained from the monitored venues 120 including, but not limited to, sensor data, video or audio data, environmental data, telemetry data geographical data, operational status data, biometrics, and a variety of other types of information for assessing and controlling the safety and security of the monitored venues 120. The term, ‘biometrics’, as used herein, refers to unique physiological and/or behavioral characteristics of a person that can be measured or identified. Example characteristics include height, weight, fingerprints, retina patterns, skin and hair color, feature characteristics, voice patterns, and any other measurable metrics associated with an individual person. Identification systems that use biometrics are becoming increasingly important security tools. Identification systems that recognize irises, voices or fingerprints have been developed and are in use. These systems provide highly reliable identification, but require special equipment to read the intended biometric (e.g., fingerprint pad, eye scanner, etc.) Because of the expense and inconvenience of providing special equipment for gathering these types of biometric data, facial recognition systems requiring only a simple video camera for capturing an image of a face have also been developed. In terms of equipment costs and user-friendliness, facial recognition systems provide many advantages that other biometric identification systems cannot. For instance, face recognition does not require direct contact with a user and is achievable from relatively far distances, unlike most other types of biometric techniques, e.g., fingerprint and retina scans. In addition, face recognition may be combined with other image identification methods that use the same input images. For example, height and weight estimation based on comparison to known reference objects within the visual field may use the same image as face recognition, thereby providing more identification data without any extra equipment. The use of facial imaging for identification can be employed in an example embodiment.

In other embodiments, sensor arrays 122 can include motion detectors, magnetic anomaly detectors, metal detectors, audio capture devices, infrared image capture devices, and/or a variety of other of data or image gathering and transmitting devices. Sensor arrays 122 can also include video cameras mounted on a mobile host. In a particularly novel embodiment, a video camera of sensor arrays 122 can be fitted to an animal. For example, camera-enabled head gear can be fitted to a substance-sensing canine deployed in a monitored venue. Such canines can be trained to detect and signal the presence of substances or interest (e.g., explosive material, incendiaries, narcotics, etc.) in a monitored venue. By virtue of the canine's skill in detecting these materials and the camera-enabled head gear fitted to them these mobile hosts can effectively place a video camera in close proximity to sources of these substances of interest. For example, on a crowded subway platform, a substance-sensing canine can isolate a particular individual among the crowd and place a video camera directly in front of the individual. In this manner, the isolated individual can be quickly and accurately identified, logged, and tracked using facial recognition technology. Conventional systems have no such capability to isolate a suspect individual and capture the suspect's biometrics at a central operations center.

Referring still to FIG. 1, real time data analysis operations center 110 of an example embodiment is shown to include a real time data analysis system 200, intranet 112, and real time data analysis database 111. Real time data analysis system 200 includes real time data acquisition module 210, historical data acquisition module 220, related data acquisition module 230, analysis tools module 240, rules manager module 250, and analytic engine 260. Each of these modules or components can be implemented as software components executing within an executable environment of real time data analysis system 200 operating at or with real time data analysis operations center 110. These modules can also be implemented in whole or in part as hardware components for processing signals and data for the environment of real time data analysis system 200. Each of these modules of an example embodiment is described in more detail below in connection with the figures provided herein.

An example embodiment can take multiple and diverse sensor input from sensor arrays 122 at the monitored venues 120 and produce sensor data streams that can be transferred across wired network 10 and/or wireless network 11 to real time data analysis operations center 110 in near real time. In an alternative embodiment, the sensor data streams can be retained in a front-end data collector or data center, which can be accessed by the operations center 110. The real time data analysis operations center 110 and the real time data analysis system 200 therein acquires, extracts, and retains the information embodied in the sensor data streams within a privileged database 111 of operations center 110 using real time data acquisition module 210. For the stationary venues 130, wired networks 10 and/or wireless networks 11 can be used to transfer the current sensor data streams to the operations center 110. Given the deployment of the sensor arrays 122 and the multiple video feeds that can result, a significant quantity of data may need to be transferred across wired networks 10 and/or wireless networks 11. Nevertheless, the appropriate resources can be deployed to support the data transfer bandwidth requirements. However, supporting the mobile venues 140 can be more challenging. The mobile venues 140 can include mass transit vehicles, such as trains, ships, ferries, buses, aircraft automobiles, trucks, and the like. The embodiments disclosed herein include a broadband wireless data transceiver capable of high data rates to support the wireless transfer of the current sensor data streams from the mobile venues 140 to the operations center 110. As such, the wireless networks 11, including a high-capacity broadband wireless data transceiver, can be used to transfer the current sensor data streams from mobile venues 140 to the operations center 110. In some cases, the mobile venues 140 can include a wired data transfer capability. For example, some train or subway systems include fiber, optical, or electrical data transmission lines embedded in the railway tracks of existing rail lines. These data transmission lines can also be used to transfer the current sensor data streams to the operations center 110. As such, the wired networks 10, including embedded data transmission lines, can also be used to transfer the current sensor data streams from mobile venues 140 to the operations center 110.

In real time, the acquired sensor data streams can be analyzed by the analysis tools module 240, rules manager module 250, and analytic engine 260. The acquired real time sensor data streams are correlated with corresponding historical data streams obtained from the sensor arrays 122 in prior time periods and corresponding related data streams obtained from other data sources, such as network-accessible databases (e.g., motor vehicle licensing databases, criminal registry databases, intelligence databases, etc.). The historical data streams are acquired, retained, and managed by the historical data acquisition module 220. The related data streams are acquired, retained, and managed by the related data acquisition module 230. In some cases, the network-accessible databases providing sources for the related data streams can be accessed using a wide-area data network such as the internet 12. In other cases, secure networks can be used to access the network-accessible databases. As described in more detail below, components within the real time data analysis system 200 can analyze, aggregate, and cross-correlate the acquired real time sensor data streams, the historical data streams, and the related data streams to identify threads of activity, behavior, and/or status present or occurring in a monitored venue 120. In this manner, patterns or trends of activity, behavior, and/or status can be identified and tracked. Over time, these patterns can be captured and retained in database 111 as historical data streams by the historical data acquisition module 220. In many cases, these patterns represent nominal patterns of activity, behavior, and/or status that pose no threat. In other cases, particular patterns of activity, behavior, and/or status can be indicative or predictive of hostile, dangerous, illegal, or objectionable behavior or events.

The various embodiments described herein can isolate and identify these potentially threating patterns of activity, behavior, and/or status and issue alerts or pre-alerts in advance of undesirable conduct. In some cases, a potentially threating pattern can be identified based on an analysis of a corresponding historical data stream. For example, a particular individual present in a particular monitored venue 120 can be identified using the real time data acquired from the sensor arrays 122 and the facial recognition techniques described above. This individual can be assigned a unique identity by the real time data analysis system 200 to both record and track the individual within the system 200 and to protect the privacy of the individual. Using the real time data acquired from the sensor arrays 122, the behavior of the identified individual can be tracked and time-stamped in a thread of behavior as the individual moves through the monitored venue 120. In a subsequent time period (e.g., the following day), the same individual may be identified in the same monitored venue 120 using the facial recognition techniques. Given the facial recognition data, the unique identity assigned to the individual in a previous time period can be correlated to the same individual in the current time period. Similarly, the thread of behavior corresponding to the individual's identity in a previous time period can be correlated to the individual's thread of behavior in the current time period. In this manner, the behavior of a particular individual can be compared with the historical behavior of the same individual from a previous time period. This comparison between current behaviors, activity, or status with historical behaviors, activity, or status from a previous time period may reveal particular patterns or deviations of activity, behavior, and/or status that can be indicative or predictive of hostile, dangerous, illegal, or objectionable behavior or events. For example, an individual acting differently today compared with consistent behavior in the prior month may be indicative of imminent conduct.

In a similar manner, the individual's current and/or historical behaviors at a first monitored venue can be compared with the individual's current and/or historical behaviors at a second monitored venue. In some cases, the threads of behavior at one venue may be indicative of behavior or conduct at a different venue. Tints, the various embodiments described herein can identify and track these threads of behaviors, activities, and/or status across various monitored venues and across different time periods.

Additionally, the various embodiments described herein can also acquire and use related data to further qualify and enhance the analysis of the real time data received from the sensor arrays 122. In an example embodiment, the related data can include related data streams obtained from other data sources, such as network-accessible databases (e.g., motor vehicle licensing databases, criminal registry databases, intelligence databases, etc.). The related data can also include data retrieved from local databases. In general, the related data streams provide an additional information source, which can be correlated to the information extracted from the real time data streams. For example, the analysis of the real time data stream from the sensor arrays 122 of a monitored venue 120 may be used to identify a particular individual present in the particular monitored venue 120 using the facial recognition techniques described above. Absent any related data, it may be difficult to determine if the identified individual poses any particular threat. However, the real time data analysis system 200 of an example embodiment can acquire related data from a network-accessible data source, such as content sources 170. The facial recognition data extracted from the real time data stream or the anonymous object identifier generated from the data stream can be used to index a database of a network-accessible content source 170 to obtain data related to the identified individual. For example, the extracted facial recognition data can be used to locate and acquire driver license information corresponding to the identified individual from a motor vehicle licensing database. Similarly, the extracted facial recognition data can be used to locate and acquire criminal arrest warrant information corresponding to the identified individual from a criminal registry database. It will be apparent to those of ordinary skill in the art that a variety of information related to an identified individual can be acquired from a variety of network-accessible content sources 170 using the real time data analysis system 200 of an example embodiment.

The various embodiments described herein can use the current real time data streams, the historical data streams, and related data streams to isolate and identify potentially threating patterns of activity, behavior, and/or status in a monitored venue and issue alerts or pre-alerts in advance of undesirable conduct. In real time, the acquired sensor data streams can be analyzed by the analysis tools module 240, rules manager module 250, and analytic engine 260. Analysis tools module 240 includes a variety of functional components for parsing, filtering, sequencing, synchronizing, prioritizing, and marshaling the current data streams, the historical data streams, and the related data streams for efficient processing by the analytic engine 260. The rules manager module 250 embodies sets of rules, conditions, threshold parameters, and the like, which can be used to define thresholds of activity, behavior, and/or status that should trigger a corresponding alert, pre-alert, and/or action. For example, as rule can be defined that specifies that: 1) when an individual enters a monitored venue 120 and is identified by facial recognition, and 2) the same individual is matched to an arrest warrant using a related data stream, then 3) an alert should be automatically issued to the appropriate authorities. A variety of rules having a construct such as, “IF <Condition> THEN <Action>” can be generated and managed by the rules manager module 250. Additionally, an example embodiment includes an automatic rule generation capability, which can automatically generate rules given desired outcomes and the conditions by which those desired outcomes are most likely. In this manner, the embodiments described herein can implement machine learning processes to improve the operation of the system over time. Moreover, an embodiment can include information indicative of a confidence level corresponding to a probability level associated with a particular condition and/or need for action.

The analytic engine 260 can cross-correlate the current data streams, the historical data streams, and the related data streams to detect patterns, trends, and deviations therefrom. The analytic engine 260 can detect normal and non-normal activity, behavior, and/or status and activity, behavior, and/or status that is consistent or inconsistent with known patterns of concern using cross-correlation between data streams and/or rules-based analysis. As a result, information can be passed by the real time data analysis system 200 to an analyst interface provided for data communication with the analyst platform 150.

The analyst platform 150 represents a stationary analyst platform 151 or a mobile analyst platform 152 at which a human analyst can monitor the analysis information presented by the real time data analysis system 200 and issue alerts or pre-alerts via the alert dispatcher 160. An alert can represent a rules violation. A pre-alert can represent the anticipation of an event. The analyst platform 150 can include a computing platform with a data communication and information display capability. The mobile analyst platform 152 can provide a similar capability in a mobile platform, such as a truck or van. Wireless data communications can be provided to link the mobile analyst platform 152 with the operations center 110. The analyst interface is provided to enable data communication with analyst platform 150 as implemented in a variety of different configurations.

The alert dispatcher 160 represents a variety of communications channels by which alerts or pre-alerts can be transmitted. These communication channels can include electronic alerts, alarms, automatic telephone calls or pages, automatic entails or text messages, or a variety of other modes of communication. In one embodiment, the alert dispatcher 160 is connected directly to real time data analysis system 200. In this configuration, alerts or pre-alerts can be automatically issued based on the analysis of the data streams without involvement by the human analyst. In this manner, the various embodiments can quickly, efficiently, and in real time respond to activity, behavior, and/or status events occurring in a monitored venue 120.

Networks 10, 11, 12, and 112 are configured to couple one computing device with another computing device. Networks 10, 11, 12, and 112 may be enabled to employ any form of computer readable media for communicating information from one electronic device to another.

Network 10 can be a conventional form of wired network using conventional network protocols. Network 11 can be a conventional form of wireless network using conventional network protocols. Proprietary data sent on networks 10, 11, 12, and 112 can be protected using conventional encryption technologies.

Network 12 can include a public packet-switched network, such as the Internet, wide area networks (WANs), direct connections, such as through a universal serial bus (USB) port, other forms of computer-readable media, or any combination thereof. On an interconnected set of LANs, including those based on differing architectures and protocols, a router or gateway acts as a link between LANs, enabling messages to be sent between computing devices. Also, communication links within LANs typically include twisted wire pair or coaxial cable links, while communication links between networks may utilize analog telephone lines, full or fractional dedicated digital lines including T1, T2, T3, and T4, Integrated Services Digital Networks (ISDNs), Digital User Lines (DSLs), wireless links including satellite links, or other communication links known to those of ordinary skill in the art.

Network 11 may further include any of a variety of wireless nodes or sub-networks that may further overlay stand-alone ad-hoc networks, and the like, to provide an infrastructure-oriented connection. Such sub-networks may include mesh networks, Wireless LAN (WLAN) networks, cellular networks, and the like. Network 11 may also include an autonomous system of terminals, gateways, routers, and the like connected by wireless radio links or wireless transceivers. These connectors may be configured to move freely and randomly and organize themselves arbitrarily, such that the topology of network 11 may change rapidly.

Network 11 may further employ a plurality of access technologies including 2nd (2G), 2.5, 3rd (3G), 4th (4G) generation radio access for cellular systems, WLAN, Wireless Router (WR) mesh, and the like. Access technologies such as 2G, 3G, 4G, and future access networks may enable wide area coverage for mobile devices, such as one or more client devices with various degrees of mobility. For example, network 11 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like.

Network 10 may include any of as variety of nodes interconnected via a wired network connection. Such wired network connection may include electrically conductive wiring, coaxial cable, optical fiber, or the like. Typically, wired networks can support higher bandwidth data transfer than similarly configured wireless networks. For legacy network support, remote computers and other related electronic devices can be remotely connected to either LANs or WAN via a modem and temporary telephone link.

Networks 10, 11, 12, 112 may also be constructed for use with various other wired and wireless communication protocols, including TCP/IP, UDP, SIP, SMS, RTP, WAP, CDMA, TDMA, EDGE, UNITS, GPRS, GSM, UWB, WiMax, IEEE 802.11x, WiFi, Bluetooth, and the like. In essence, networks 10, 11, 12, and 112 may include virtually any wired and/or wireless communication mechanisms by which information may travel between one computing device and another computing device, network, and the like, in one embodiment, network 112 may represent a LAN that is configured behind a firewall (not shown), within a business data center, for example.

The content sources 170 may include any of a variety of providers of network transportable digital content. This digital content can include a variety of content related to the monitored venues 120 and/or individuals or events being monitored within the monitored venue 120. The networked content is often available in the form of a network transportable digital file or document. Typically, the file format that is employed is Extensible Markup Language (XML), however, the various embodiments are not so limited, and other file formats may be used. For example, data formats other than Hypertext Markup Language (HTML)/XML or formats other than open/standard data formats can be supported by various embodiments. Any electronic file format, such as Portable Document Format (PDF), audio (e.g., Motion Picture Experts Group Audio Layer 3—MP3, and the like), video (e.g., MP4, and the like), and any proprietary interchange format defined by specific content sites can be supported by the various embodiments described herein.

In a particular embodiment, the analyst platform 150 and the alert dispatcher 160 can include a computing platform with one or more client devices enabling an analyst to access information from operations center 110 via an analyst interface. The analyst interface is provided to enable data communication between the operations center 110 and the analyst platform 150 as implemented in a variety of different configurations. These client devices may include virtually any computing device that is configured to send and receive information over as network or as direct data connection. The client devices may include computing devices, such as personal computers (PCs), multiprocessor systems, microprocessor-based or programmable consumer electronics, network PC's, and the like. Such client devices may also include mobile computers, portable devices, such as, cellular telephones, smart phones, display pagers, radio frequency (RF) devices, infrared (IR) devices, global positioning devices (GPS), Personal Digital Assistants (PDAs), handheld computers, wearable computers, tablet computers, integrated devices combining one or more of the preceding devices, and the like. As such, the client devices may range widely in terms of capabilities and features. For example, a client device configured as a cell phone may have a numeric keypad and a few lines of monochrome LCD display on which only text may be displayed. In another example, a web-enabled client device may have, a touch sensitive screen, a stylus, and several lines of color LCD display in which both text and graphics may be displayed. Moreover, the web-enabled client device may include as browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML). Wireless Markup Language (WML), WMLScript, JavaScript, EXtensible HTML)(xHTML), Compact HTML (CHTML), and the like, to display and send a message with relevant information.

The client devices may also include at least one client application that is configured to receive content or messages from another computing device, via a network transmission or a direct data connection. The client application may include a capability to provide and receive textual content, graphical content, video content, audio content, alerts, messages, notifications, and the like. Moreover, client devices may be further configured to communicate and/or receive a message, such as through a Short Message Service (SMS), direct messaging (e.g., Twitter), email, Multimedia Message Service (MMS), instant messaging (IM), internet relay chat (IRC), mIRC, Jabber, Enhanced Messaging Service (FMS), text messaging. Smart Messaging, Over the Air (OTA) messaging, or the like, between another computing, device, and the like. Client devices may also include a wireless application device on which a client application is configured to enable a user of the device to send and receive information to/from network sources wirelessly via a network.

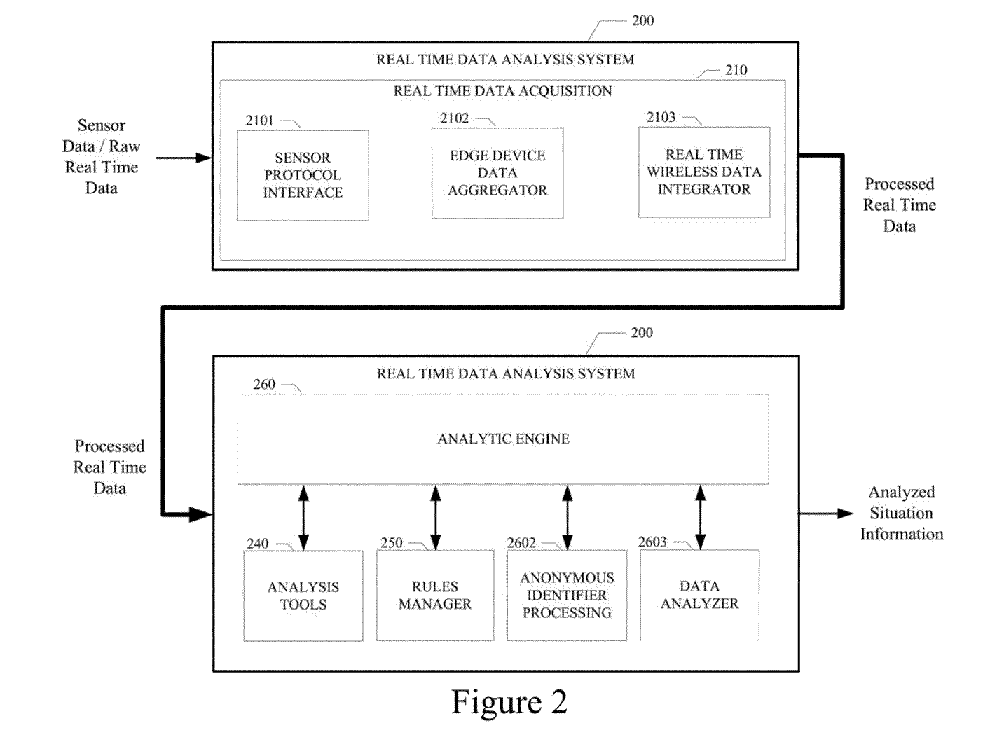

Referring now to FIG. 2, a system diagram illustrates the functional components of the real time data analysis system 200 of an example embodiment. As shown, the real time data analysis system 200 includes a real time data acquisition module 210 and analytic engine 260. The real time data analysis system 200 uses real time data acquisition module 210 to acquire, extract, and retain the information embodied in the sensor data streams within a privileged database 111 of operations center 110. The real time data analysis system 200 uses analytic engine 260 to extract information from the real time data in the acquired sensor data streams. FIG. 2 illustrates the flow and processing of data from the raw sensor data streams through the real time data acquisition module 210 and then through the analytic engine 260. As a result, raw real time sensor data is processed into useful analyzed situation information that can be used by an analyst at the analyst platform ISO to assess activity and potential threats at as monitored venue 120 and take appropriate action.

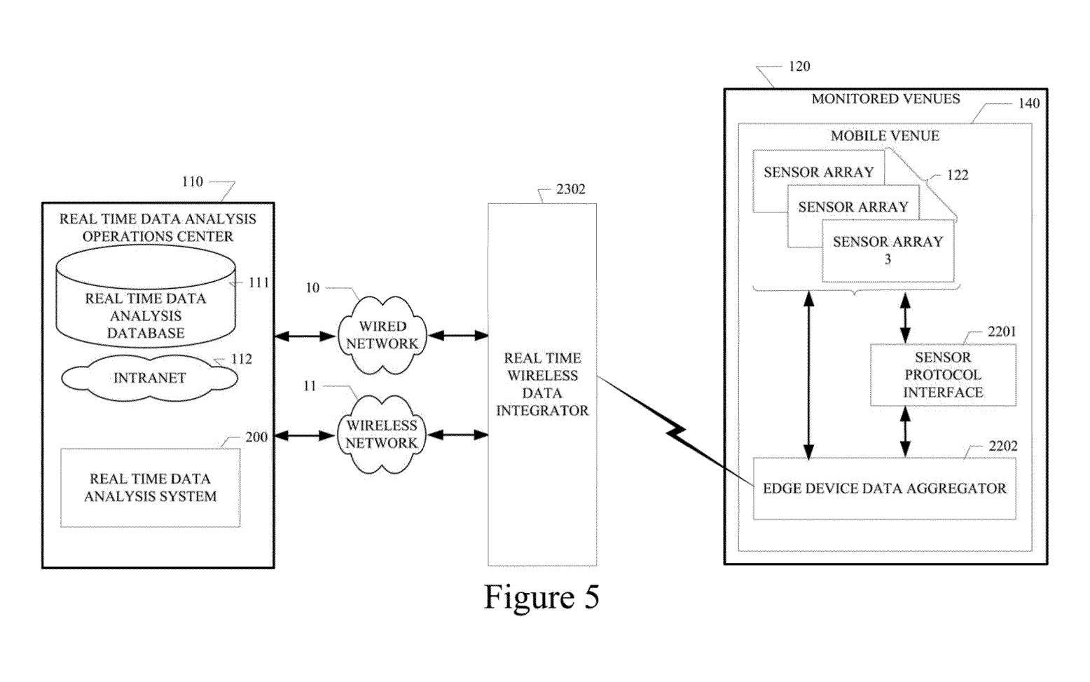

Referring still to FIG. 2, the real time data acquisition module 210 of an example embodiment is shown to include a sensor protocol interface 2101, an edge device data aggregator 2102, and a real time wireless data integrator 2103. It will be apparent to those of ordinary skill in the art that these components can be combined together in a single unit or deployed separately as independent components. For example, in an example embodiment described in more detail below and illustrated in FIG. 5 for a mobile venue 140, the sensor protocol interface 2201, edge device data aggregator 2202, and real time wireless data integrator 2302 are deployed separately from the real time data analysis system 200. The sensor protocol interface 2101 provides a processing engine for converting data from a variety of different sensing devices into a uniform sensor data interface. Because the sensor arrays 122 in a particular monitored venue 120 can include a wide variety of different sensors, possibly manufactured by different manufacturers, the sensor data provided by the sensor arrays 122 can be a highly heterogeneous data set. For example, the data provided by a metal detector is not the same type of data and is typically formatted differently than the data provided by a temperature sensor. Similarly, video stream data from two video cameras manufactured by two different camera manufacturers can be in completely different formats. The sensor protocol interface 2101 can convert these heterogeneous sensor data sets into homogeneous sensor data sets with consistent formats and data structures, which can be more easily and quickly processed by downstream data processing modules.

The edge device data aggregator 2102 is a collector of raw data feeds from video cameras, sensors, and telemetry units. In one embodiment, the edge device data aggregator 2102 can receive a portion of the raw data feeds via the sensor protocol interface 2101. The edge device data aggregator 2102 can receive raw video feeds from a plurality of video cameras positioned at various locations in a monitored venue 120. Similarly, the edge device data aggregator 2102 can receive raw sensor data from a plurality of sensors positioned at various locations in a monitored venue 120. Examples of the various types of sensors in an example embodiment are listed below. Additionally, the edge device data aggregator 2102 can receive telemetry data generated at the monitored venue 120. The telemetry data can include, for example, speed/rate, GPS (global positioning system) location, engine status, brake status, control system status, track status, and a variety of other data. In one embodiment, the edge device data aggregator 2102 can be installed at or proximately to the monitored venue 120. For example, the monitored venue 120 might be a railcar of a subway train. The railcar can be fitted with a set of video cameras and a variety of sensors. Additionally, the railcar can be fitted with a telemetry unit to gather the telemetry data related to the movement and status of the railcar and the track on which the railcar rides. The variety of sensors can include sensors for detecting any of the following conditions: temperature, radiologicals, nuclear materials, chemicals, biologicals, explosives, microwaves, biometrics, active infrared (TR), capacitance, vibration, fiber optics, glass breakage, network intrusion detection (NIBS), human intrusion detection (HIDS), radio frequency identification (RFID), wireless MAC addresses, motion detectors, magnetic anomaly detectors, metal detectors, pressure, audio, and the like, in one embodiment, the railcar can also be titled with the edge device data aggregator 2102. Each of the data feeds from the set of video cameras, the set of sensors, and the telemetry device on the railcar can be connected to the edge device data aggregator 2102 directly or via the sensor protocol interface 2101. In most cases, these data feeds can be connected to the edge device data aggregator 2102 via wired connections or wirelessly using conventional WiFi or Bluetooth close proximity wireless technology. In this manner, the edge device data aggregator 2102 can receive a plurality of data feeds from a plurality of sensor arrays 122 at a particular monitored venue 120. Because the edge device data aggregator 2102 can receive and aggregate input and data feeds from a variety of different devices, the edge device data aggregator 2102 of an example embodiment includes a variety of physical connectors, such as analog video inputs (e.g., coaxial, Composite. S-Video and Component YPbPr connectors), digital video inputs (e.g., DVI, HDMI), audio inputs (e.g., RCA jacks), Controller Area Network (CAN) bus connectors, On Board Diagnostics (OBD) connectors, Ethernet, USB, and other connector types for receiving input and data feeds from a variety of different devices. Further, the edge device data aggregator 2102 of an example embodiment can be configured to aggregate the received raw input and data feeds and deliver at an output a modified form of the aggregated raw data. For example, the edge device data aggregator 2102 may receive data at a first sampling rate, collect the data for a configured length of time, and deliver an average or aggregation of the raw data at a second sampling rate. In another example, the edge device data aggregator 2102 of an example embodiment can be configured to filter or modify the raw data according to pre-determined criteria, such as applying, high or low band pass filters, shifting the data to a different frequency domain, adjusting the gain of the raw data signals, performing error correction, performing data compression, performing data encryption, and the like, it will be apparent to those of ordinary skill in the art that a variety of processing operations can be performed by the edge device data aggregator 2102 on the received raw input and data feeds. As a result, the edge device data aggregator 2102 can deliver a more compact, more accurate, and more secure sensor data set for processing by the real time wireless data integrator 2103.

Once the edge device data aggregator 2102 has received the data feeds from the various sensor arrays 122, the edge device data aggregator 2102 can perform a variety of processing operations on the raw sensor data. In one embodiment, the edge device data aggregator 2102 can simply marshal the raw sensor data and send the combined sensor data to the real time wireless data integrator 2103. The real time wireless data integrator 2103 can use wireless and wired data connections to transfer the sensor data to the analytic engine 260 as described in more detail below. In another embodiment, the edge device data aggregator 2102 can perform several data processing operations on the raw sensor data. For example, the edge device data aggregator 2102 can stamp (e.g., add meta data to) the data set from each sensor with the time/date and geo-location corresponding to the time and location when/where the data was captured. This time and location information can be used by downstream processing systems to synchronize the data feeds from the sensor arrays 122. Additionally, as described above, the edge device data aggregator 2102 can perform other processing operations on the raw sensor data, such as, data filtering, data compression, data encryption, error correction, local backup, and the like. In one embodiment, the edge device data aggregator 2102 can also be configured to perform the same image analysis processing locally at the monitored venue 120 as would be performed by the analytic engine 260 as described in detail below. Alternatively, the edge device data aggregator 2102 can be configured to perform a subset of the image analysis processing as would be performed by the analytic engine 260. In this manner, the edge device data aggregator 2102 can act as a local (monitored venue resident) analytic engine for processing the sensor data without transferring the sensor data back to the operations center 110. This capability is useful if communications to the operations center 110 is lost for a period of time. Using any of the embodiments described herein, the edge device data aggregator 2102 can process the raw sensor data and send the processed real time sensor data (including video, audio, and telemetry data) to the real time wireless data integrator 2103.

The real time wireless data integrator 2103 can receive the processed real time data from the edge device data aggregator 2102 as a broadband wireless data signal. A wireless transceiver in the edge device data aggregator 2102 is configured to communicate wirelessly with one of a plurality of wireless transceivers provided as part of a wireless network enabled by the real time wireless data integrator 2103. The plurality of wireless transceivers of the real time wireless data integrator 2103 network can be positioned at various geographical locations within or adjacent to a monitored venue 120 to provide continuous wireless data coverage for a particular region in or near a monitored venue 120. For example, a plurality of wireless transceivers of the real time wireless data integrator 2103 network can be positioned along a rail or subway track and at a rail or subway station to provide wireless data connectivity for a railcar or subway train operating on the track. In this example, the wireless transceiver in the edge device data aggregator 2102 located in the railcar is configured to communicate wirelessly with one of a plurality of wireless transceivers of the real time wireless data integrator 2103 network positioned along the track on which the railcar is operating. As the railcar moves down the track, the railcar moves through the coverage area for each of the plurality of wireless transceivers of the real time wireless data integrator 2103 network. Thus, the wireless transceiver in the edge device data aggregator 2102 can remain in constant network connectivity with the real time wireless data integrator 2103 network. Given this network connectivity, the real time wireless data integrator 2103 can receive the processed real time data from the edge device data aggregator 2102 at very high data rates.

Referring still to FIG. 2, having received the processed real time data from the monitored venue 120 as described above, the real time wireless data integrator 2103 can use wireless and/or wired network data connections to transfer the processed real time data to the analytic engine 260 at the operations center 110 via wired networks 10 and/or wireless networks 11. In some cases, the real time wireless data integrator 2103 can use a wired data transfer capability to transfer the processed real time data to the analytic engine 260. For example, some train or subway systems include fiber, optical, or electrical data transmission lines embedded in the railway tracks of existing rail lines. These embedded data communication lines can be used to transfer the processed real time data to the analytic engine 260.

In one embodiment, the processed real time data is transferred from the real time wireless data integrator 2103 to a set of front end data collectors. These data collectors can act as data centers or store-and-forward data repositories from which the analytic engine 260 can retrieve data according to the analytic engine's 260 own schedule. In this manner, the processed real time data can be retained and published to the analytic engine 260 and to other client applications, such as command/control applications or applications operating at the monitored venue 120. The analytic engine 260 and the client applications can access the published processed real time data via a secure network connection.

Referring still to FIG. 2, the analytic engine 260 receives the processed real time data via the real time data acquisition system 210 as described above. The analytic engine 260 can also receive the historical data streams and related data streams as described above. The analytic engine 260 is responsible for processing these data streams, including the real time data received from the sensor arrays 122. As shown in FIG. 2, the acquired data streams can be analyzed by the analysis tools module 240, the rules manager module 250, the anonymous identifier processing module 2602, and the data analyzer 2603 of the analytic engine 260. These components of the analytic engine 260 are described, in more detail below.

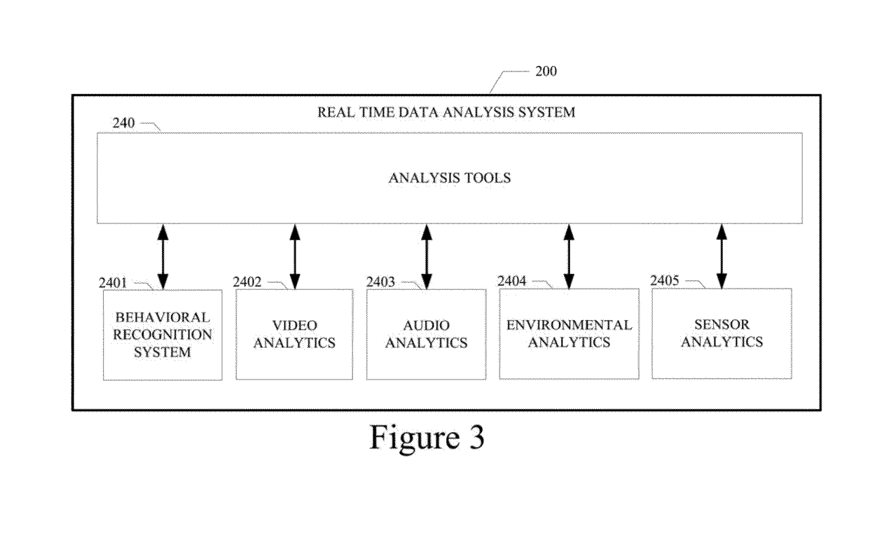

The analysis tools module 240, of an example embodiment, includes a variety of functional components for parsing, filtering, sequencing, synchronizing, prioritizing, analyzing, and marshaling the real time data streams, the historical data streams, and the related data streams for efficient processing by the other components of the analytic engine 260. The details of an example embodiment of the analysis tools module 240 are shown in FIG. 3.

Referring now to FIG. 3, details of an example embodiment of the analysis tools module 240 are shown. In the example embodiment, the analysis tools module 240 is shown to include a behavioral recognition system 2401, as video analytics module 2402, an audio analytics module 2403, an environmental analytics module 2404, and a sensor analytics module 2405. The behavioral recognition system 2401 is used for analyzing and learning the behavior of objects (e.g., people) in a monitored venue 120 based on an acquired real time data stream. In one embodiment, objects depicted in the real time data stream (e.g., a video stream) can be identified based on an analysis of the frames in the video stream. Each object may have a corresponding behavior model used to track an object's motion frame-to-frame, in this manner, an object's behavior over time in the monitored venue 120 can be analyzed. One such behavioral recognition system is described in U.S. Pat. No. 8,131,012. The behavioral analysis information gathered or generated by the behavioral recognition system 2401 can be received by the analysis tools module 240 and provided to the analytic engine 260. The video analytics module 2402 can be used to perform a variety of processing operations on a real time video stream received from a monitored venue 120. These processing operations can include: video image filtering, color or intensity adjustments, resolution or pixel density adjustments, video frame analysis, object extraction, object tracking, pattern matching, object integration, rotation, zooming, cropping, and a variety of other operations for processing a video frame. The video analysis data gathered or generated by the video analytics module 2402 can be provided to the analytic engine 260. The audio analytics module 2403 can be used to perform a variety of audio processing operations on a real time video or audio stream received from a monitored venue 120. These processing operations can include: audio filtering, frequency analysis, audio signature matching, ambient noise suppression, and the like. The audio analysis data gathered or generated by the audio analytics module 2403 can be provided to the analytic engine 260. The environmental analytics module 2404 can be used to gather and process various environmental parameters received from various sensors at the monitored venue 120. For example, temperature, pressure, humidity, lighting level, and other environmental data can be collected and used to infer environmental conditions at a particular monitored venue 120. This environmental data gathered or generated by the environmental analytics module 2404 can be provided to the analytic engine 260. The sensor analytics module 2405 can be used to gather and process various other sensor parameters received from various sensors at the monitored venue 120. This sensor data gathered or generated by the sensor analytics module 2405 can be provided to the analytic engine 260.

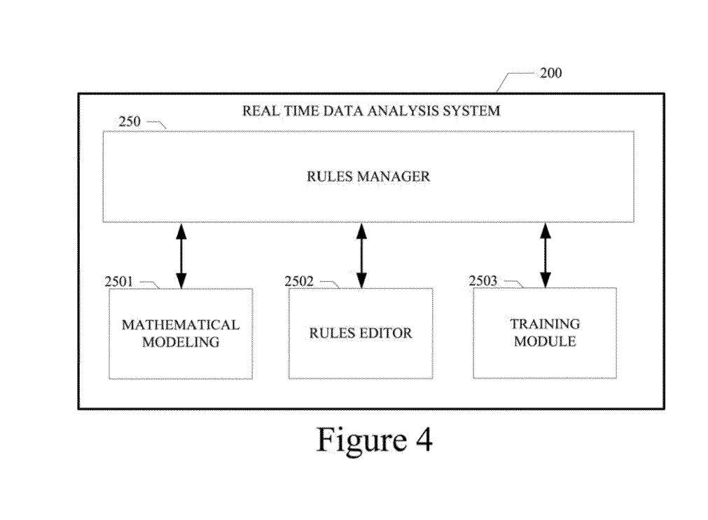

Referring now to FIG. 4, an example embodiment of the components of the rule manager 250 is illustrated. As described above, the rules manager module 250 embodies sets of rules, conditions, threshold parameters, and the like, which can be used to define thresholds of activity, behavior, and/or status that should trigger a corresponding alert, pre-alert, and/or action. In an example embodiment, the rules manager 250 includes a mathematical modeling module 2501, as rules editor 2502, and a training module 2503. The mathematical modeling module 2501 provides the decision logic for implementing sets of rules that define actions to be triggered based on a set of conditions. For example, a variety of rules having a construct such as, “IF <Condition> THEN <Action>” can be generated and managed by the rules editor 2502. In an example embodiment, the rules manager 250 provides an automatic rule generation capability, which can automatically generate rules given desired outcomes and the conditions by which those desired outcomes are most likely. In this manner, the embodiments described herein can implement machine learning processes to improve the operation of the system over time. The training module 2503 can be used to train and configure these machine learning processes.

### Edge Device Data Aggregator

Referring now to FIG. 5, an example embodiment illustrates the data acquisition systems for acquiring security information or biometrics at a mobile venue 140, wherein the sensor protocol interface 2201, edge device data aggregator 2202, and real time wireless data integrator 2302 are deployed in or adjacent to the mobile venue 140. As described above, the mobile venues 140 can include mass transit vehicles, such as trains, Ships, ferries, buses, aircraft, automobiles, trucks, military vehicles, and the like. As such, it is beneficial to deploy the data acquisition systems in or adjacent to the mobile venue 140. As shown in FIG. 5, a particular mobile venue 140 can be configured with as plurality of sensors, cameras, microphones, telemetry data capture devices, GPS devices, motion detection devices, and a variety of other security data and biometric data capture devices in sets of sensor arrays 122. As described above, the sensor protocol interface component 2201 provides a processing engine for converting data from a variety of different sensing devices of the sensor arrays 122 into a uniform sensor data interface. Because the sensor arrays 122 in as particular monitored venue 120 can include a wide variety of different sensors, possibly manufactured by different manufacturers, the sensor data provided by the sensor arrays 122 can be a highly heterogeneous data set. For example, the data provided by a metal detector is not the same type of data and is typically formatted differently than the data provided by a temperature sensor. Similarly, video stream data from two video cameras manufactured by two different camera manufacturers can be in completely different formats. The sensor protocol interface 2201 can convert these heterogeneous sensor data sets into homogeneous sensor data sets with consistent formats and data structures, which can be more easily and quickly processed by downstream data processing modules.

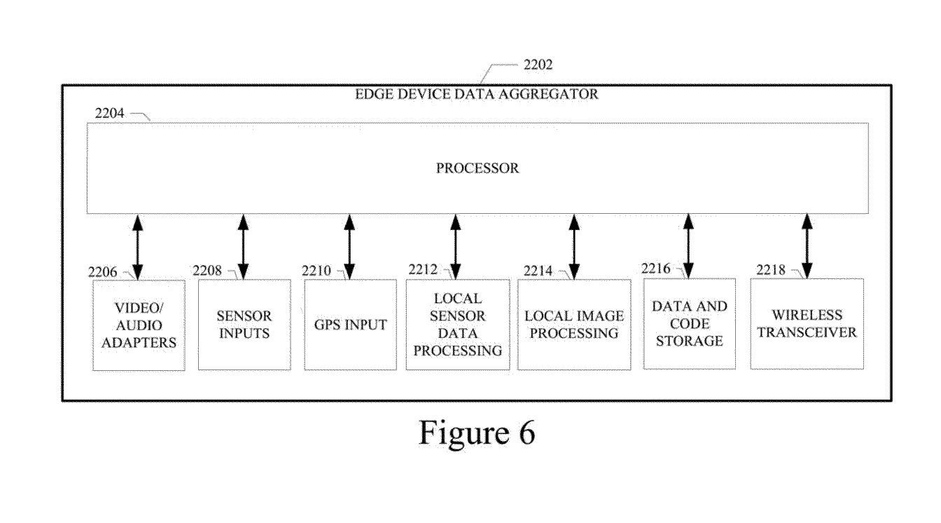

Referring now to FIG. 6, an example embodiment illustrates the structural components of the edge device data aggregator 2202. As shown, the edge device data aggregator 2202 in an example embodiments is shown to include a video/audio adapters 2206, sensor inputs 2208. GPS input 2210, local sensor data processing 2212, local image processing 2214, data and code storage 2216, and a wireless transceiver 2218. One or more of these components of the edge device data aggregator 2202 can be implemented as software or firmware functional components executable by the processor 2204. These software or firmware functional components can be downloaded and updated in the edge device data aggregator 2202 via, a network and stored in the data and code storage component 2216. Alternatively, one or more of these components of the edge device data aggregator 2202 can be implemented as hardware components or field programmable gate array (FPGA) devices.

Referring still to FIGS. 5 and 6, the edge device data aggregator 2202 is a collector of raw data feeds from video cameras, audio microphones, sensors, telemetry units, and/or any other source of security data or biometric data in the mobile venue 140. In one embodiment, the edge device data aggregator 2202 can receive a portion of the raw data feeds via the sensor protocol interface 2201. For example, the edge device data aggregator 2202 can receive raw video feeds or audio reeds from a plurality of video cameras and/or microphones positioned at various locations in a mobile venue 140. The video/audio adapter component 2206 is provided to receive these video or audio feeds. Similarly, the edge device data aggregator 2202 can receive raw sensor data from a plurality of sensors positioned at various locations in as mobile venue 140. Examples of the various types of sensors in an example embodiment are listed below. Additionally, the edge device data aggregator 2202 can receive telemetry data generated at the mobile venue 140. The telemetry data can include, for example, speed/rate, GPS (global positioning system) location, engine status, brake status, control system status, track status, and a variety of other data related to the operation, movement, and status of a particular mobile venue 140, such as a railcar. In one embodiment, the edge device data aggregator 2202 is installed within the mobile venue 140. For example, the mobile venue 140 might be a railcar of a subway train. The railcar can be fitted with a set of video cameras and a variety of sensors. Additionally, the railcar can be fitted with a telemetry unit to gather the telemetry data related to the operation, movement, and status of the railcar and the track on which the railcar rides. The variety of sensors in the sensor arrays 122 of the mobile venue 140 can include sensors for detecting any of the following conditions: temperature, radiologicals, nuclear materials, chemicals, biologicals, explosives, microwaves, biometrics, active infrared (IR), capacitance, vibration, fiber optics, glass breakage, network intrusion detection (NIDS), human intrusion detection (HIDS), radio frequency identification (RFID), wireless MAC addresses, motion detectors, magnetic anomaly detectors, metal detectors, pressure, audio, and the like. In one embodiment, the railcar, or other mobile venue 140, can also be fitted with the edge device data aggregator 2202. The sensor inputs component 2208 and GPS input component 2210 are provided to receive these sensor and telemetry inputs. Each of the data feeds from the set of video cameras, the set of sensors, the telemetry device, and other sources of security or biometric data on the railcar can be connected to the edge device, data aggregator 2202 directly or via the sensor protocol interface 2201 as shown in FIG. 5. In most cases, these data feeds can be connected to the edge device data aggregator 2202 via wired connections or wirelessly using conventional WiFi or Bluetooth close proximity wireless technology. In this manner, the edge device data aggregator 2202 can receive a plurality of data feeds from a plurality of sensor arrays 122 at a particular mobile venue 140.

Once the edge device data aggregator 2202 has received the data feeds from the various sensor arrays 122, the edge device data aggregator 2202 can perform a variety of processing operations on the raw sensor data using the local sensor data processing component 2212 and the local image processing component 2214. In one embodiment, the edge device data aggregator 2201 can use the local sensor data processing component 2212 to simply marshal the raw sensor data and send the combined sensor data to the real time wireless data integrator 2302 via the wireless transceiver 2218, as described in more detail below. The real time wireless data integrator 2302 can use wireless and wired data connections to transfer the sensor data to the analytic engine 260 as described in more detail below. In another embodiment, the edge device data aggregator 2202 can use the local sensor data processing component 2212 to perform several data processing operations on the raw sensor data. For example, the edge device data aggregator 2202 can stamp (e.g., add meta data to the data set from each sensor with the time/date and geo-location corresponding to the time and location when/where the data was captured. This time and location information can be used by downstream processing systems to synchronize the data feeds from the sensor arrays 122. Additionally, the edge device data aggregator 2202 can use the local sensor data processing component 2212 to perform other processing operations on the raw sensor data, such as, data filtering, data compression, data encryption, error correction, local backup, and the like. In one embodiment, the edge device data aggregator 2202 can use the local image processing component 2214 to perform the same or similar image analysis processing locally at the mobile venue 140 as would be performed by the analytic engine 260 as described in detail below. Alternatively, the edge device data aggregator 2202 can use the local image processing component 2214 to perform a subset of the image analysis processing as would be performed by the analytic engine 260. In this manner, the edge device data aggregator 2202 can act as a local (mobile venue resident) analytic engine for processing the sensor data without transferring the sensor data back to the operations center 110. This capability is useful if communications to the operations center 110 is lost for a period of time. Using any of the embodiments described herein, the edge device data aggregator 2202 can process the raw sensor data and send the processed real time sensor data (including video, audio, biometrics, and telemetry data) to the real time wireless data integrator 2302 using the wireless transceiver 2218.

### Real Time Wireless Data Integrator

Referring again to FIG. 5, the real time wireless data integrator 2302 can receive the processed real time data from the edge device data aggregator 2202 as a broadband wireless data signal. The wireless transceiver 2218 in the edge device data aggregator 2202 is configured to communicate wirelessly with one of a plurality of wireless transceivers provided as part of as wireless network enabled by the real time wireless data integrator 2302.

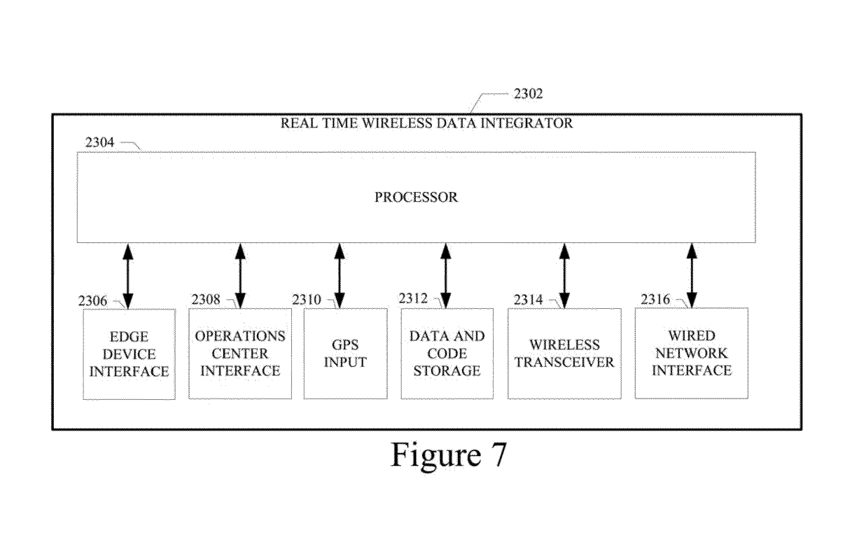

Referring now to FIG. 7, an example embodiment illustrates the structural components of the real time wireless data integrator 2302. As shown, the real time wireless data integrator 2302 in an example embodiments is shown to include an edge device interface 2306, an operations center interface 2308. GPS input 2310, data and code storage 2312, a wireless transceiver 2314, and a wired network interface 2316. One or more of these components of the real time wireless data integrator 2302 can be implemented as software or firmware functional components executable by the processor 2304. These software or firmware functional components can be downloaded and updated in the real time wireless data integrator 2302 via a network and stored in the data and code storage component 2312. Alternatively, one or more of these components of the real time wireless data integrator 2302 can be implemented as hardware components or field programmable gate array (FPGA) devices.

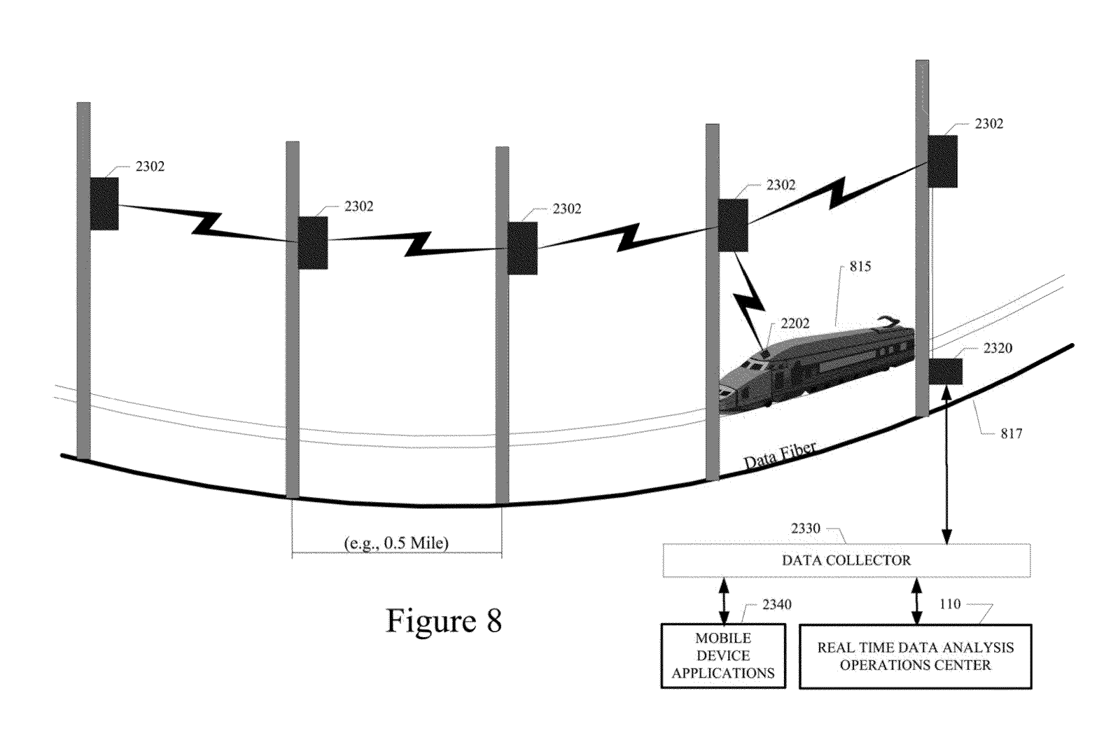

Referring now to FIG. 8, an example embodiment illustrates a system environment in which the real time wireless data integrator 2302 can operate. A plurality of real time wireless data integrators 2302 can be positioned, at various geographical locations within or adjacent to a mobile venue 140, such as a railcar 815, to provide continuous wireless data coverage for a particular region in or near the mobile venue 140. For example, as shown in FIG. 8, a plurality of real time wireless data integrators 2302 can be positioned along a rail or subway track and at a rail or subway station to provide wireless data connectivity for a railcar or subway train 815 operating on the track. As shown in FIG. 8, the plurality of real time wireless data integrators 2302 can inter-communicate using their wireless transceivers 2314 to form a network of real time wireless data integrators 2302 adjacent to the mobile venue 140. Additionally, in one example embodiment, the plurality of real time wireless data integrators 2302 can inter-communicate using, a wired data communication line 817 to form the network of real time wireless data integrators 2302 adjacent to the mobile venue 140. The wired network interface 2316 in the real time wireless data integrator 2302 can be provided to enable data communication on a wired communication line. Some existing rail tracks are configured with wired data communication lines 817 (e.g., fiber optic data carriers). The UPS input 2310 in each of the plurality of real time wireless data integrators 2302 can be used to provide geographical location awareness for each of the plurality of real time wireless data integrators 2302.

In the example environment shown in FIG. 8, the wireless transceiver 2218 in the edge device data aggregator 2202 located in the railcar 815 is configured to communicate wirelessly with at least one of the plurality of wireless transceivers 2314 of the real time wireless data integrator 2302 network positioned along the track on which the railcar 815 is operating. The edge device interface 2306 in the real time wireless data integrator 2302 can be provided for this purpose. As the railcar 815 moves down the track, the railcar 815 moves through the coverage area for each of the plurality of wireless transceivers 2314 of the real time wireless data integrator 2302 network. Thus, the wireless transceiver 2218 in the edge device data aggregator 2202 can remain in constant network connectivity with the real time wireless data integrator 2302 network. Given this network connectivity, the real time wireless data integrator 2302 can receive the processed real time data from the mobile venue 140 via the edge device data aggregator 2202 in the railcar 815 at very high data rates.

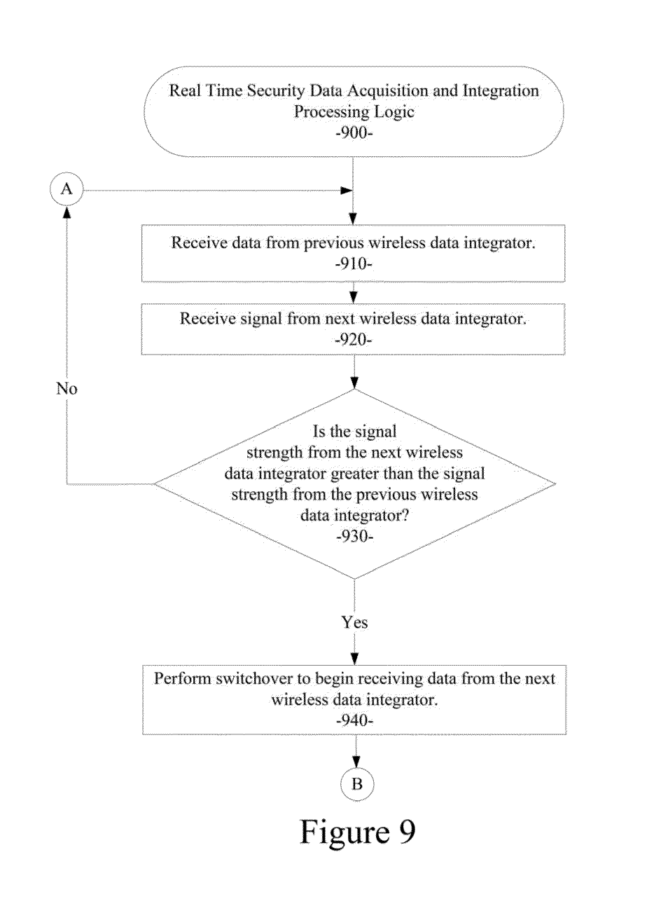

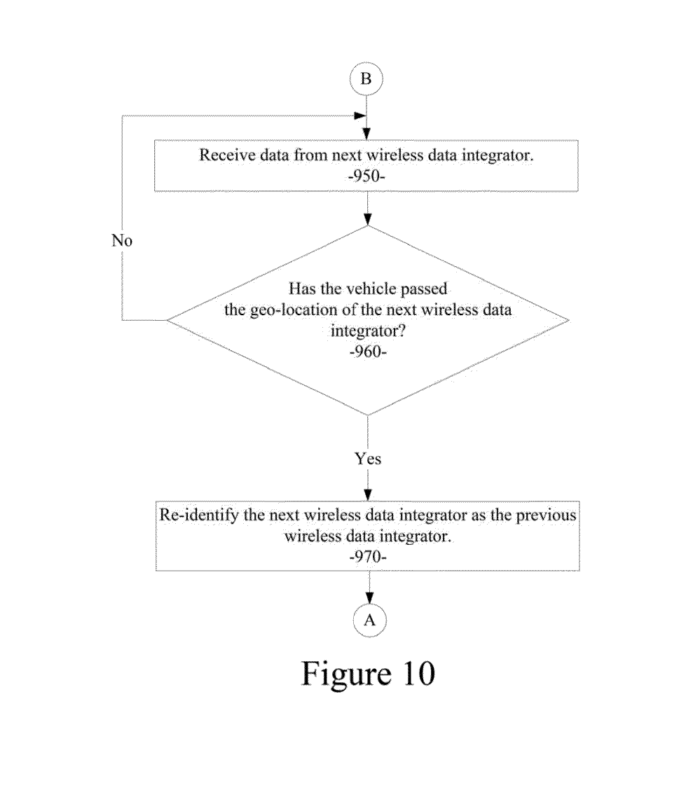

In an example embodiment, the edge device data aggregator 2202 can remain in constant network connectivity with the real time wireless data integrator 2302 network using a handoff protocol described in FIGS. 9 and 10. Referring to FIGS. 9 and 10, to processing flow chart illustrates an example embodiment of a system and method for real time handoff of data communications in a security data acquisition and integration system as described herein. As the railcar 815 moves down the track as shown in FIG. 8, the railcar 815 moves through the coverage area for each of the plurality of wireless transceivers 2314 of the real time wireless data integrator 2302 network. As a result, the edge device data aggregator 2202 in the train can receive wireless signals, at times, from two of the real time wireless data integrators 2302 positioned along the track. One of these two real time wireless data integrators 2302 is ahead of the train and can be denoted the arrival (or next) wireless data integrator. The other of the two real time wireless data integrators 2302 is behind the train and can be denoted the departure (or previous) wireless data integrator. The train is approaching the arrival wireless data integrator; thus, the signal received from the arrival, wireless data integrator by the edge device data aggregator 2202 in the train is increasing in strength and clarity. Conversely, the train is traveling away from the departure wireless data integrator; thus, the signal received from the departure wireless data integrator by the edge device data aggregator 2202 in the train is decreasing in strength and clarity. At a point between the geo-location of the arrival wireless data integrator and the geo-location of the departure wireless data integrator (typically near the midpoint depending on geographical and environmental conditions), the signal strength from the arrival wireless data integrator and the signal strength from the departure wireless data integrator becomes roughly equal. This point can be denoted the handoff point. Initially, the edge device data aggregator 2202 in the train can be configured to communicate primarily with the departure wireless data integrator. The edge device data aggregator 2202 can receive and transmit data packets wirelessly via the departure wireless data integrator as long as the signal strength of the departure wireless data integrator is sufficiently strong to support data communications with an acceptable low level of data packet loss. Eventually, the signal strength of the departure wireless data integrator will decrease to an unacceptable level as the train gets farther away from the geo-location of the departure wireless data integrator. However, the real time wireless data integrator 2302 network can be configured so the train will reach the handoff point prior to reaching the point where the signal strength of the departure wireless data integrator has decreased to an unacceptable level. Thus, at the handoff point, the edge device data aggregator 2202 in the train can be configured to perform a switchover, which causes the edge device data aggregator 2202 to begin to communicate primarily with the arrival wireless data integrator instead of the departure wireless data integrator. The edge device data aggregator 2202 can then begin to receive and transmit data packets wirelessly via the arrival wireless data integrator as long as the signal strength of the arrival wireless data integrator is sufficiently strong to support data communications with an acceptable low level of data packet loss. As the train passes the geo-location of the arrival wireless data integrator, the arrival wireless data integrator becomes the departure wireless data integrator and the process ran repeat with a next handoff point as described above. The switchover event can be performed between the transfers of data packets. Thus, the transfer of data is not affected by the transition from the departure for previous) wireless data integrator to the arrival (or next) wireless data integrator.

Referring again to FIG. 9, a processing flow chart illustrates an example embodiment of a system and method for real time handoff of data communications in a security data acquisition and integration system as described herein. Beginning at processing block 910, an example embodiment receives data from a previous (or departure) wireless data integrator. The example embodiment also receives a wireless signal from a next (or arrival) wireless data integrator at processing block 920. At decision block 930, if the signal strength from the next wireless data integrator is less than or equal to the signal strength from the previous wireless data integrator, processing continues through bubble A at the processing block 910. If the signal strength from the next wireless data integrator is greater than the signal strength from the previous wireless data integrator, processing continues at the processing block 940. At the processing block 940, the example embodiment performs a switchover to begin receiving data from the next wireless data integrator. Processing continues through bubble B at the processing block 950 illustrated in FIG. 10.

Referring now to FIG. 10, the wireless data integrator handoff processing continues through bubble 13 at the processing block 950. At the processing block 950, the example embodiment receives data from next wireless data integrator. At decision block 960, if the vehicle has not passed the geo-location of the next wireless data integrator, processing continues at the processing block 950. If the vehicle has passed the geo-location of the next wireless data integrator, processing continues at the processing, block 970. At the processing block 970, the example embodiment re-identifies the next wireless data integrator as the previous wireless data integrator. Processing then continues through bubble A at the processing block 910 illustrated in FIG. 9 and described above.

Referring again to FIG. 5, having received the processed real time data from the mobile venue 140 as described above, the real time wireless data integrator 2302 can use wireless and/or wired network data connections to transfer the processed real time data to the analytic engine 260 at the operations center 110 via wired networks 10 and/or wireless networks 11. In some cases, the real time wireless data integrator 2302 can use a wired data transfer capability to transfer the processed real time data to the analytic engine 260. For example, some train or subway systems include fiber, optical, or electrical data transmission lines 817 embedded in the railway tracks of existing; rail lines. These embedded data communication lines 817 or wireless data communications can be used to transfer the processed real time data to the analytic engine 260 at the operations center 110. The operations center interface 2308 in the real time wireless data integrator 2302 can be used thr this purpose.

In one embodiment shown in FIG. 8, the processed real time data is transferred from the real time wireless data integrator 2302 network, via a router 2320, to a set of front end data collectors 2330. These data collectors 2330 can act as data centers or store-and-forward data repositories from which the analytic engine 260 at the operations center 110 can retrieve data according to the analytic engine's 260 own schedule. In this manner, the processed real time data can be retained and published to the analytic engine 260 and to other client applications 2340, such as command/control applications or applications operating at the mobile venue 140 or elsewhere. The analytic engine 260 at the operations center 110 and the client applications 2340 can therefore access the published processed real time data from the mobile venue 140 via a secure network connection.

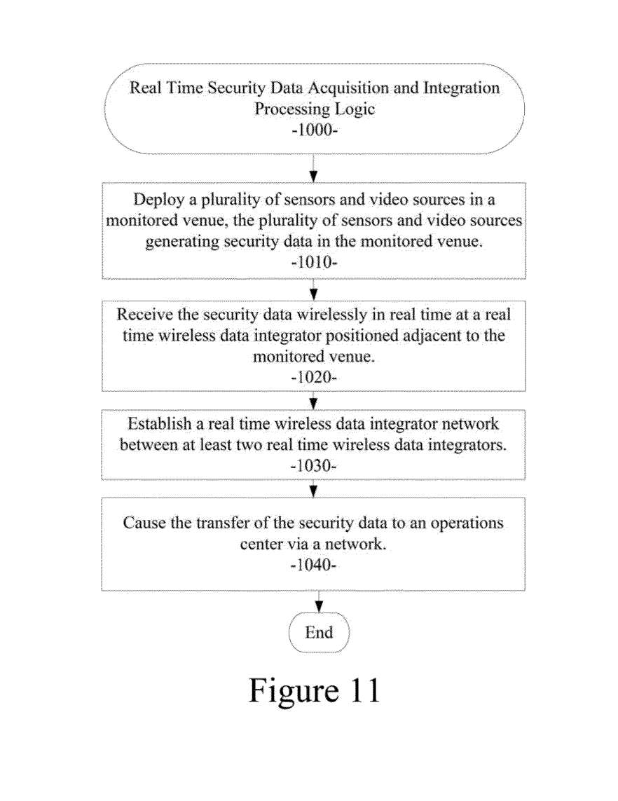

FIG. 11 is a processing flow diagram illustrating an example embodiment of a system and method for real time security data acquisition and integration from mobile platforms as described herein. The method of an example embodiment includes: deploying a plurality of sensors and video sources in as monitored venue, the plurality of sensors and video sources generating security data in the monitored venue (processing block 1010); receiving the security data wirelessly in real time at a real time wireless data integrator positioned adjacent to the monitored venue (processing block 1020); establishing a real time wireless data integrator network between at least two real time wireless data integrators (processing block 1030); and causing the transfer of the security data to an operations center via a network (processing block 1040).

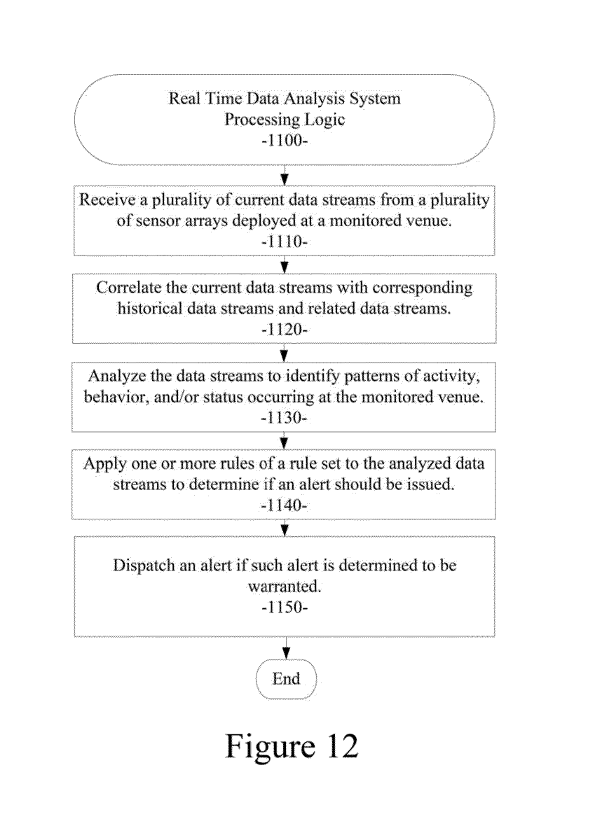

FIG. 12 is a processing, flow diagram illustrating an example embodiment system and method for real time data analysis as described herein. The method of an example embodiment includes: receiving a plurality of current data streams from a plurality of sensor arrays deployed at a monitored venue (processing block 1110); correlating the current data streams with corresponding historical data streams and related data streams processing block 1120); analyzing, by use of a data processor, the data streams to identify patterns of activity, behavior, an for status occurring at the monitored venue (processing block 1130); applying one or more rules of a rule set to the analyzed data streams to determine if an alert should be issued (processing block 1140); and dispatching an alert if such alert is determined to be warranted (processing block 1150).

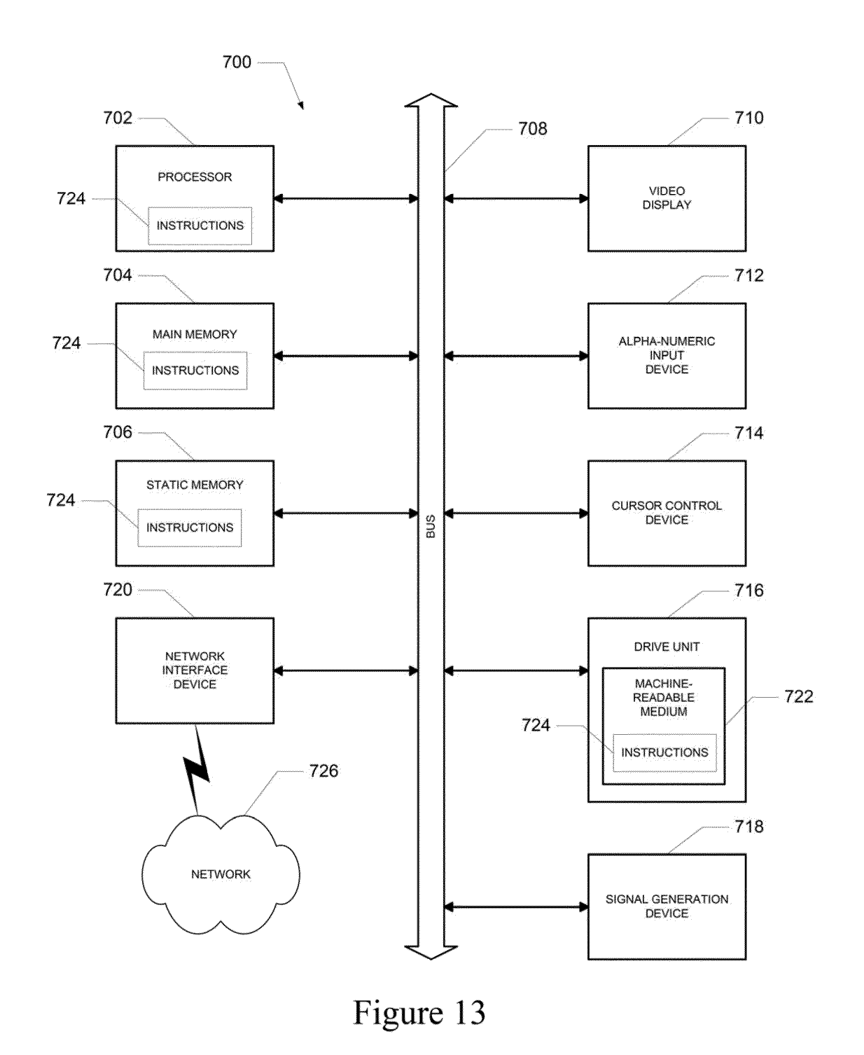

FIG. 13 shows a diagrammatic representation of a machine in the example limn of a computer system 700 within which a set of instructions when executed may cause the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, a video camera, image or audio capture device, sensor device, or any machine capable of executing as set of instructions (sequential or otherwise) that specify actions to be taken by that machine. Further, while only a single machine is illustrated, the term “machine” can also be taken to include any collection of machines that individually or jointly execute a set (or multiple sets) of instructions to perform any one or more of the methodologies discussed herein.

The example computer system 700 includes a data processor 702 (e.g., a central processing unit (CPU) graphics processing unit (GPU), or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an input device 712 (e.g., a keyboard), a cursor control device 714 (e.g., a mouse), a disk drive unit 716, a signal generation device 718 (e.g., a speaker) and a network interface device 720.

The disk drive unit 716 includes a non-transitory machine-readable medium 722 on which is stored one or more sets of instructions (e.g., software 724) embodying any one or more of the methodologies or functions described herein. The instructions 724 may also reside, completely or at least partially, within the main memory 704, the static memory 706, and/or within the processor 702 during execution thereof by the computer system 700. The main memory 704 and the processor 702 also may constitute machine-readable media. The instructions 724 may further be transmitted or received over a network 726 via the network interface device 720. While the machine-readable medium 772 is shown in an example embodiment to be a single medium, the term “machine-readable medium” should be taken to include a single non-transitory medium or multiple media (e.g., a centralized or distributed database, and/or associated caches and servers) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

We claim:

1. A method comprising:
deploying a plurality of sensors and video sources in a monitored venue, the plurality of sensors and video sources generating security data in the monitored venue;
receiving the security data wirelessly in real time at a real time wireless data integrator positioned adjacent to the monitored venue;
establishing a real time wireless data integrator network between at least two real time wireless data integrators; and
causing the transfer of the security data to an operations center via a network.

2. The method as claimed in claim 1 wherein the security data includes sensor data, video data, audio data, and telemetry data.

3. The method as claimed in claim 1 wherein the security data is received from the monitored venue via a broadband wireless data signal.

4. The method as claimed in claim 1 including causing the transfer of the security data to a data collector via a network.

5. The method as claimed in claim 1 wherein the real time wireless data integrator includes a wireless transceiver for establishing the real time wireless data integrator network between at least two real time wireless data integrators via a wireless data connection.

6. The method as claimed in claim 1 wherein the real time wireless data integrator includes as wired network interface for establishing the real time wireless data integrator network between at least two real time wireless data integrators via a wired data connection.

7. The method as claimed in claim 1 wherein the monitored venue is a mobile venue from the group: mass transit vehicle, military vehicle, train, railcar, ship, ferry, buses, aircraft, automobile, and truck.

8. The method as claimed in claim 1 including causing the transfer of the security data to the operations center via either a wired network or a wireless network.

9. The method as claimed in claim 1 including performing a switchover to change from receiving the security data from a first real time wireless data integrator to receiving the security data from a second real time wireless data integrator.

10. A system comprising:
a plurality of sensor arrays and video sources deployed in a monitored venue; and
a real time wireless data integrator deployed adjacent to the monitored venue and in data communication with the plurality of sensor arrays and video sources via a wireless data connection, the real time wireless data integrator including, processing modules to:
receive security data wirelessly in real time from the plurality of sensors arrays and video sources deployed in the monitored venue;
establish a real time wireless data integrator network between at least two real time wireless data integrators; and
cause the transfer of the security data to an operations center via a network.

11. The system as claimed in claim 10 wherein the security data includes sensor data video data audio data, and telemetry data.

12. The system as claimed in claim 10 wherein the security data is received from the monitored venue via a broadband wireless data signal.

13. The system as claimed in claim 10 being further configured to cause the transfer of the security data to a data collector via a network.

14. The system as claimed in claim 10 wherein the real time wireless data integrator includes a wireless transceiver for establishing the real time wireless data integrator network between at least two real time wireless data integrators via a wireless data connection.

15. The system as claimed in claim 10 wherein the real time wireless data integrator includes a wired network interface for establishing the real time wireless data integrator network between at least two real time wireless data integrators via a wired data connection.

16. The system as claimed in claim 10 wherein the mobile venue is from the group: mass transit vehicle, military vehicle, train, railcar, ship, ferry, buses, aircraft, automobile, and truck.

17. The system as claimed in claim 10 being further configured to cause the transfer of the security data to the operations center via either a wired network or a wireless network.

18. A real time wireless data integrator comprising:
an edge device interface component to receive security data from a plurality of sensors and a plurality of video sources deployed in a monitored venue;
a wireless transceiver to receive the security data from the monitored venue via a broadband wireless data signal and to establish a real time wireless data integrator network between at least two real time wireless data integrators; and
an operations center interface to cause the transfer of the security data to an operations center via a network.

19. The real time wireless data integrator as claimed in claim 18 wherein the security data includes sensor data, video data, audio data, and telemetry data.

20. The real time wireless data integrator as claimed in claim 18 wherein the at least one processing operation includes a processing operation from the group: filtering, data compression, data encryption, error correction, and local backup.

21. The real time wireless data integrator as claimed in claim 18 wherein the mobile venue is from the group: mass transit vehicle, military vehicle, train, railcar, ship, ferry, buses, aircraft, automobile, and truck.
